(19) United States
(12) Patent Application Publication
(10) Pub. No.: US 2002/0052664 A1
(43) Pub. Date: May 2, 2002

(54) Signal processing apparatus

(76) Inventors: I-Chih Kang, Eindhoven (NL); Albert Van Der Werf, Eindhoven (NL)

Correspondence Address: U.S. Philips Corporation, 580 White Plains Road, Tarrytown, NY, 10591, US

(21) Appl. No.: 09/952,059

(22) Filed: Sep. 14, 2001

(30) Foreign Application Priority Data
Sep. 15, 2000 (NL) 00203188.8

(51) Int. Cl. G06F 17/00

(52) U.S. Cl. 700/94

(57) ABSTRACT

A signal processing apparatus for processing signals like video, audio or graphics contains signal processor units that produce and consume a stream of data items relating to samples along at least one dimension of an at least one dimensional physical signal. The processor units communicate the data via a memory. Memory address indicators indicating the regions in memory where the data-items are stored are passed between the processor units via a FIFO channel. The control signal outputs of the FIFO channel are use to provide synchronization between the processor units.

Processing of media signals like video signals, audio signals and graphics signals requires a high throughput processing apparatus. These signals represent one or higher dimensional, humanly perceptible information as a function of for example time and/or spatial x/y directions. Samples represent this information at successive sampling points along these dimensions. Together, these samples form a vast amount of information that have to be processed at least real-time, that is, keeping up with the speed with which the media signals develop.

Processing signal data items that correspond to successive sampling points involves subjecting the signal data item for each sampling point to a series of different processing steps. For example, for MPEG decoding, each signal data item represents a block of pixels and contains a set of coefficients for that block of pixels. MPEG decoding involves decoding the coefficients, rearranging them and performing an IDCT transform.

In order to keep up with the required processing speed it is known to perform such processing steps in parallel. Different signal processor units are provided, each performing a specific processing task. A signal processor receives a stream of data-items, performs its processing task on each data item and passes its result to a next signal processor unit for performing a next task. Thus, the next signal processor unit in turn receives a stream of data items and the processor units perform different tasks on the streams in parallel.

The signal processor units have to be synchronized with one another in order to operate properly, for example to ensure that a receiver processor unit starts processing a signal data-item once that signal data-item has been produced by a source signal processor unit. One way of realizing synchronization is to use lock-step synchronization. In this case, the signal processor units are arranged so that each signal processor unit uses exactly the same number of processing cycles before the signal processor unit starts with the next signal data-item. When the different signal processor units are started with a proper delay relative to one another, this ensures that each signal processor unit will have exactly one new signal data item at its input precisely when it finishes processing the preceding signal data-item. Lock-step operation requires a very tight coupling between the signal processor units, which often makes it difficult to make full use of their processing capabilities. For example, when the number of processing cycles needed to process a signal data-item is variable, it is necessary to pause the signal processor unit each time that it needs less than the maximum number of processing cycles. Moreover, lock-step operation requires specialized design and considerable overhead.

To ease the problems with lock-step operation, it has been known to use FIFO channels between the different signal processor units. FIFO channels are known per se. A FIFO channel has room for storing a plurality of signal data-items. In a FIFO channel, writing of data items by a source signal processor is not dependent on processing by the receiver signal processor unit. The FIFO channel merely stores the signal data items produced by the source signal processor unit and indicates to that unit whether the FIFO channel has room for writing more signal data-items. The FIFO channel indicates to the receiver signal processor unit whether the FIFO channel is empty or not, allowing the receiver signal processor unit to read signal data-items from the FIFO channel when desired. Thus, writing into the FIFO channel and reading from the FIFO channel are not synchronized to each other, other than that writing must cease when the FIFO is full and reading must cease when the FIFO channel is empty, but when the FIFO channel contains storage space for a sufficient number of signal data items, say four or more, this does not lead to unnecessary slow down of the signal processor units.

The use of a FIFO channel for passing signal data items from one signal processor unit makes it possible to use the capabilities of the signal processor units more fully and it simplifies design, but FIFO channels with a considerable amount of memory are needed to store a sufficient number signal data-items. If the signal data-items have to be sent to multiple signal processing units that operate independently, multiple FIFO channels are needed, each with such a large amount of storage space for signal data-items. Similarly, if the signal data-items from a first signal processor unit are received and manipulated with a second signal processor unit and passed to a third signal processor unit, two FIFO channels are needed, each with such a large amount of storage space.

Amongst others, it is an object of the invention to provide for a signal processing apparatus with a number of signal processor units that are capable of operating in parallel and that are loosely coupled, in which the required amount of memory space for the FIFO channels can be reduced.

The signal processing apparatus according to the invention is set forth in claim 1. According to the invention, a FIFO channel between two signal processor units is used to pass memory address indicators that each indicate the address of a region in a memory where a signal data-item is stored. In this way, one obtains the advantage of the loose synchronization provided by a FIFO channel in combination with a significantly reduced amount of storage needed for the FIFO channel, because only the indicators and not the entire signal data item needs to be stored.

This can be applied for example if a first signal processor unit receives the memory address indicators from a FIFO channel, modifies the signal data items in memory and passes the memory address indicators to a second signal processor unit. Thus, the same memory regions can be used by each signal processor unit, without putting the signal data-items into different FIFO channels. In another example, the first signal processing unit merely rearranges the sequence of the memory address indicators. Thus, shuffling required for example for time interleaving or matrix transposition is performed without having to copy the signal data-items to different FIFO channels (in fact even without accessing the memory with the first signal processor unit, thus reducing the required bus bandwidth to the memory). In an example of this, during image processing an image is divided into lines and the lines are divided into “stripes”, each containing for example 16 pixels. Each data-item contains data for a stripe (for example 16 pixel values). By rearranging the sequence of the memory address indicators, data for which the memory address indicators arrive linewise at a signal processor unit can be changed to data for which the memory address indicators leave the processor unit block wise, in blocks of a plurality of stripes (e.g. 16 stripes) in the direction transversal to the lines, before the memory address indicators are followed by memory address indicators for successive blocks in the line direction. In a further example, two or more streams of memory address indicators comprising the same memory address indicators is output to two or more FIFO channels, connected to different signal processor units (or different ports of the same signal processor units). Thus, it is not necessary to output copies of the underlying signal data-items to the different FIFO channels.

An embodiment of the signal processing apparatus according to the invention is set forth in claim 2. This embodiment comprises a return FIFO channel between the signal processor units. The memory address indicators are passed from a first signal processor unit to a second signal processor unit to indicate the region of memory where the first signal processor unit has written the signal data-items. The second signal processor units passes these memory address indicators back to the first signal processor unit, so that the first signal processor unit can reuse the regions in memory for subsequent data items. Thus, the first signal processor unit does not need to obtain different memory regions each time it writes a new signal data-item. In a further embodiment a set of memory address indicators is inserted into the return FIFO channel initially. This enables the FIFO channel mechanism to trigger the signal processor units to start processing. Preferably, the return FIFO channel is also used to synchronize operation of the first and second signal processor units. Note that the memory address indicators need not return (and be reused) in the sequence in which they have originally been sent.

In case the memory address indicators are passed from one signal processor unit to another along a series of signal processor units, only the last processor unit in the series preferably has a return FIFO channel to the first signal processor unit in the series. The intermediate signal processor units in the series need not have such a return FIFO channel. Alternatively, there may be a chain of return FIFO channels along (part of) the series of signal processor units. This allows a more modular design and it may allow an intermediate signal processor unit in the series to perform some wrap up processing once it is informed that a signal data-item has been received.

In case copies of the memory address indicators are output from a first signal processor unit to different FIFO channels to different signal processor units, preferably return FIFO channels are used corresponding to each of these FIFO channels. In this case the first signal processor unit reuses the memory region indicated by a memory address indicator when the first signal processor has received back the memory address indicators from all return FIFO channels. This may be implemented by keeping a counter for each memory region involved, the counter being updated for each returned memory address indicator and the region being reused once it is detected that the counter reaches a predetermined value.

These and other advantageous aspects of the signal processor apparatus and signal processing method according to the invention will be described in more detail using the following figures.

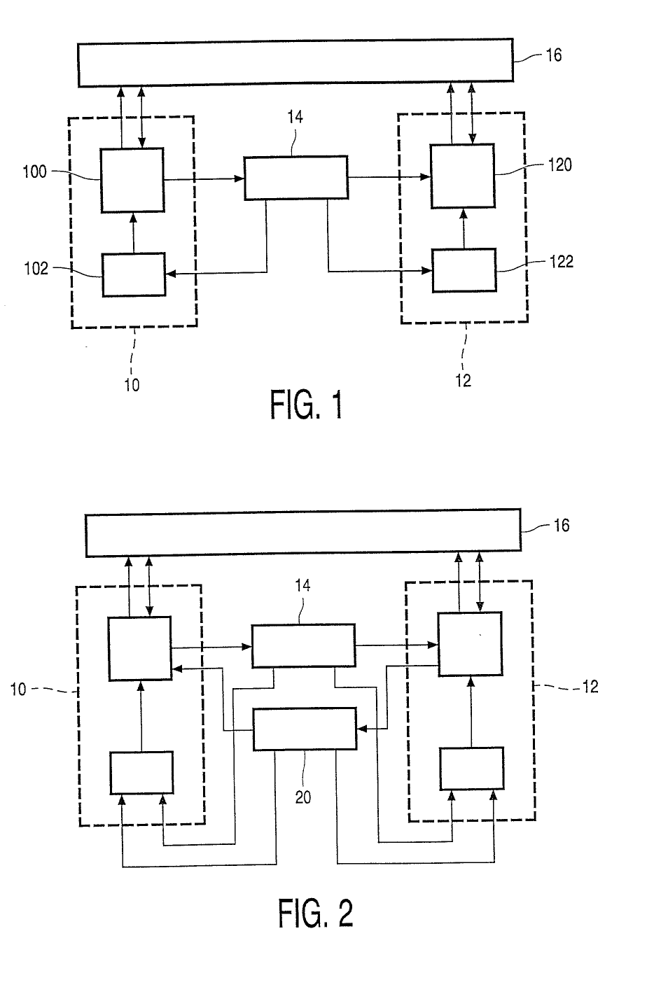

FIG. 1 shows a part of a first signal processing apparatus;

FIG. 2 shows a part of a second signal processing apparatus;

FIG. 3 shows a part of a third signal processing apparatus;

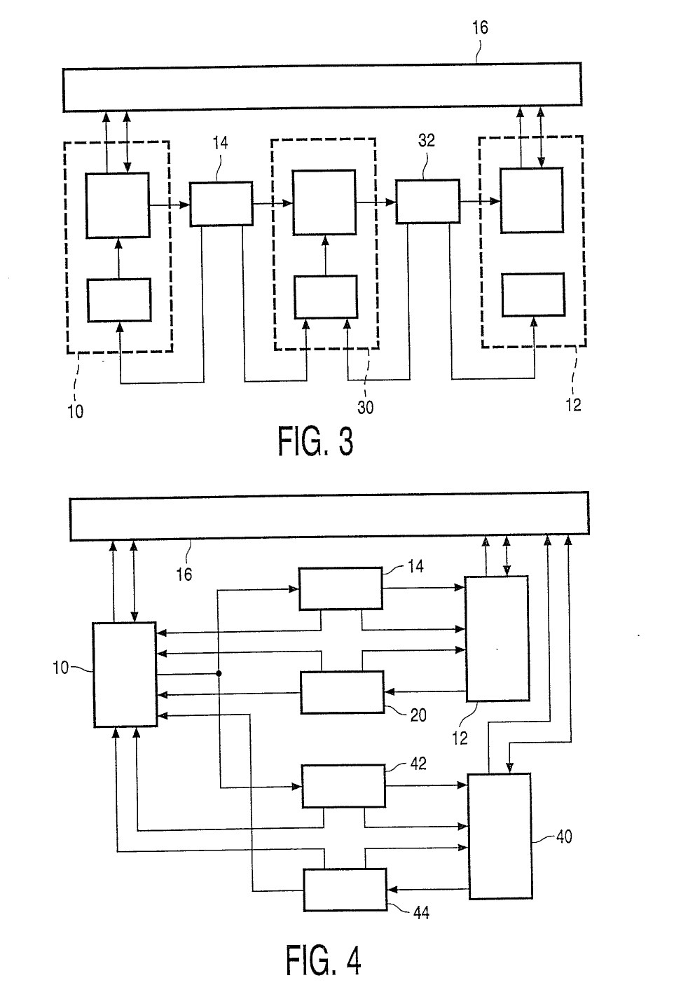

FIG. 4 shows a part of a fourth signal processing apparatus.

FIG. 1 shows part of a signal processing apparatus. The apparatus contains a first signal processor unit 10, a second signal processor unit 12, a FIFO channel 14 (First In First Out channel) and a memory 16. The first signal processor 10 contains a signal processing core 100 and a controller 102. The signal processing core 100 is connected to a data input of the FIFO channel 14. The second signal processor 12 contains a signal processing core 120 and a controller 122. A data output of the FIFO channel 14 is connected to an input of signal processing unit 120. The FIFO channel 14 has a “FIFO full/not full” output coupled to the controller 102 of the first signal processor unit 10, which in turn has a control output coupled to the processor core 100. The FIFO channel 14 has a “FIFO empty/not empty” output coupled to the controller 122 of the second signal processor unit 12, which in turn has a control output coupled to the processor core 120. The processor cores 100, 120 have an interface to the memory 16. In the figure, the memory 16 is shown as a dual port memory, the processor cores 100, 120 being coupled to different memory ports, but alternatively the processor cores 100, 120 may also be coupled to a single port of the memory 16 via a common bus (not shown). The processor cores may be dedicated processor cores, for example for performing a discrete cosine transform on a data item that represents a block of pixel values or a coefficients for such a block, or for example Huffman compressor units etc. The processor cores can also be more general purpose processor units, programmed to perform a specific signal processing task. In a simple, buf slow embodiment several processor cores might even be implemented with different programs running on the same processing hardware.

In operation, the controller 102 in the first processor unit 10 monitors the full/not full output of the FIFO channel 14. The processor core 100 of the first processor unit computes a data-item and writes it to a region in memory 16 that is allocated for that data-item. If this output indicates that the FIFO is not full, the controller 102 allows the processor core 100 to applies a memory address indicator of the region where the data-item has been written (for example a memory address of the start of the region in memory where the data item is stored) to FIFO channel 14. Once the processor core 100 has written the memory address indicator, the processor core 100 may start generating a next data item.

The controller 122 in the second processor unit 12 monitors the empty/not empty output of the FIFO channel 14. If this output indicates that FIFO is not empty, the controller 122 signals the processor core 120 to process a data-item. When the processor core 120 has time to start processing a new data item and the controller 122 signals that this is possible, the processor core 120 reads a memory address indicator from the output of the FIFO channel. The processor core 120 uses the memory address indicator to read at least of the data-item from the region in memory 16 indicated by the memory address indicator and processed the data-item.

FIG. 2 shows part of a signal processing apparatus similar to that of FIG. 1. In addition to the components shown in FIG. 1, FIG. 2 shows a return FIFO channel 20. The return FIFO channel 20 has a data input coupled to the processor core of the second processor unit 12 and a data output coupled to the processor core of the first data processor unit 10. The return FIFO channel 20 has a full/not full output coupled to the controller of the second processor unit 12 and an empty/not empty output coupled to the controller of the first processor unit 10.

In operation, the controller of the second processor unit 12 allows the processor core of the second processor unit 12 to return a memory address indicator to return FIFO channel 20 after processing the corresponding data-item only if the return FIFO channel indicates that it is not full. The controller of the first signal processing unit 10 allows the processor core of the first processor unit 10 to start writing data for a data-item to memory 16 only if the return FIFO channel 20 indicates that the return FIFO channel 20 is not empty. In that case, the processor core loads a memory address indicator from the return FIFO channel 20 and uses this indicator to address a region in memory 16 where the data-item is stored.

FIG. 3 shows part of a signal processing apparatus similar to that of FIG. 2. In addition to the components shown in FIG. 1, FIG. 2 shows an intermediate signal processor unit 30 and a further FIFO channel 32. The FIFO channel 14 is connected between the first processor unit 10 and the intermediate processor unit 30. The further FIFO channel 32 is connected between the intermediate processor unit 30 and the second processor unit 12.

In operation, the FIFO channel 14 operates with respect to the first processor unit 10 and the intermediate processor unit 30 as described for the FIFO channel 14 in FIG. 1 with respect to the first and second processor unit 10, 12 respectively. Similarly, the further FIFO channel 14 operates with respect to the intermediate processor unit 30 and the second processor unit 12 as described for the FIFO channel 14 in FIG. 1 with respect to the first and second processor unit 10, 12 respectively. The return FIFO channel 20 operates as described in FIG. 2.

The intermediate signal processor unit 30 inputs memory address indicators from the FIFO channel 14 and outputs these memory address indicators in a reshuffled order to further FIFO channel 32. The intermediate processor unit 30 does not access the data-items in the regions indicated by the memory address indicators. Such an intermediate processor unit 30 has an application in MPEG encoding. MPEG requires some reshuffling of incoming frames. One represents successive incoming blocks during MPEG denoding by

mblocks[t][0], mblocks[t][1], mblocks[t][2], mblocks[t+1][0],

mblocks[t+1][1], mblocks[t+1][2]

and so on for increasing time “t”. MPEG decoding requires that such blocks be reshuffled before being applied to a compressor processor unit. The compressor processor unit requires the blocks in the following order

mblocks[t][0], mblocks[t−1][1], mblocks[t−1][2], mblocks[t+1][0],

mblocks[t][1], mblocks[t][2]

and so on. By using a memory address indicator for each one of the “mblocks”, reshuffling is easily implemented with the intermediate processor unit 30, allowing the entire system to operate as a pipeline that processes blocks one by one.

FIG. 4 shows part of a signal processing apparatus similar to that of FIG. 2. In addition to the components shown in FIG. 1, FIG. 2 shows a third signal processor unit 40, a further FIFO channel 42 and a further return FIFO channel 44. The further FIFO channel 42 is connected between the first processor unit 12 and the third processor unit 40. The further FIFO return channel 44 is connected between the third processor unit 12 and the first processor unit 40.

In operation, the FIFO channel 14 and the return FIFO channel 20 operate with respect to the first and second processor unit 10, 12 as described with respect to FIG. 2. The further FIFO channel 42 and the further return FIFO channel 44 operate with respect to the first and third processor unit 10, 40 as described for the first and second processor unit 10, 12 for respect to FIG. 2. The only exception is that the first processor unit 10 inputs the memory address indicators from both return FIFO channels 20, 44 and checks which memory address indicators have been received from both return FIFO channels 20, 44. Once the same memory address indicator has been received back from both return FIFO channels 20, 24 the processor core of the first processor core is allowed to start writing data for a new data item to the region indicated by that memory address indicator.

Without deviating from the invention, the second and third processor unit 12, 40 may be replaced by a chain of processor units, like the chain containing the intermediate processor unit 30 and the second processor unit 12 in FIG. 3. Similarly the first processor unit 10 may be connected as shown to more than the first and third processor units 12, 40. In this case, a memory address indicator must be returned from all return FIFO channels, before the first processor unit 10 uses the corresponding region in memory 16 to write a new data item. The first processor unit 10 may use locations in memory 16, each location corresponding to a respective memory address indicator value, to maintain a count of the number of times that memory address indicator value has been returned. Once it follows from that count that the memory address indicator has been returned from all return channel have been returned, the corresponding region in memory is resued. Of course, these counter values need not be kept in memory: separate counter registers (not shown) may be used as an alternative.

The apparatus according to the invention can be applied to data items for any size. For example, a data-item might correspond the image location(s) of a single pixel, a entire image frame, an image line, a block of pixels. a stripe of pixels in a block etc. The larger the data-item, the more memory will be saved by the invention. However, by using relatively smaller data-items the amount of parallelism during processing can be increased, because each processor unit has to process less information at a time.

1. A signal processing apparatus, comprising
a memory;
a source signal processor unit, arranged to write a series of signal data items to the memory, successive signal data items relating to samples along at least one dimension of an at least one dimensional physical signal;
a receiver signal processor unit, arranged to read the series of signal data items from the memory;
a FIFO channel between the source signal processor unit and the receiver signal processor unit, the source signal processor unit being arranged to successively send memory address indicators to the receiver signal processor unit via the FIFO channel, each memory address indicator indicating an address of a region in the memory where one of the signal data items has been written, when that one of the signal data items is available for reception, reading and writing of the receiver signal processor unit and the source signal processor unit respectively being synchronized to one another through the availability of the FIFO channel for emptying and filling the FIFO channel in a FIFO sequence.

2. A signal processing apparatus according to claim 1, the apparatus comprising a return FIFO channel coupled between the receiver signal processor unit and the source signal processor unit, the receiver signal processor unit being arranged to successively send the memory address indicators back to the source signal processor unit via the return FIFO channel, when the receiver signal processor unit has finished reading the corresponding signal data-items, the source signal processor unit receiving the memory address indicators back from the return FIFO channel, the source signal processor unit reusing the corresponding region of the memory for writing a subsequent signal data item.

3. A signal processing apparatus according to claim 1, comprising initialization means arranged to insert a set of memory address indicators in the return FIFO, the memory address indicators indicating regions of memory allocated to the source signal processor unit for writing the data-items, the initialization means inserting at least one of the set of memory address indicators prior to start-up of processing by the source signal processor unit.

4. A signal processing apparatus according to claim 2, wherein reading and writing of the receiver signal processor unit and the source signal processor unit respectively are synchronized to one another through the availability of the FIFO channel and the return FIFO channel for emptying and filling the FIFO channel and the return FIFO channel in their respective FIFO sequences.

5. A signal processing apparatus according to claim 1, comprising a reordering signal processor unit and a further FIFO channel, the source signal processor unit being coupled to the reordering signal processor unit via the FIFO channel, the reordering signal processor unit being coupled to the receiver signal processor unit via the further FIFO channel, the reordering signal processor unit being arranged to receive the memory address indicators from the FIFO channel in an incoming sequence and to send the received memory address indicators to the receiver signal processor unit in a rearranged sequence that differs from the incoming sequence, operation of the receiver signal processor unit and the source signal processor unit being synchronized to one another through the availability of the FIFO channel for emptying and filling the FIFO channel in the incoming FIFO sequence, operation of the receiver signal processor unit and the reordering signal processor unit being synchronized to one another through the availability of the further FIFO channel for emptying and filling the further FIFO channel in the rearranged FIFO sequence.

6. A signal processing apparatus according to claim 2, comprising a reordering signal processor unit and a further FIFO channel, the source signal processor unit being coupled to the reordering signal processor unit via the FIFO channel, the reordering signal processor unit being coupled to the receiver signal processor unit via the further FIFO channel, the reordering signal processor unit being arranged to receive the memory address indicators from the FIFO channel in an incoming sequence and to send the received memory address indicators to the receiver signal processor unit in a rearranged sequence that differs from the incoming sequence, operation of the receiver signal processor unit and the source signal processor unit being synchronized to one another through the availability of the FIFO channel for emptying and filling the FIFO channel in the incoming FIFO sequence, operation of the receiver signal processor unit and the reordering signal processor unit being synchronized to one another through the availability of the further FIFO channel for emptying and filling the further FIFO channel in the rearranged FIFO sequence, writing by the source signal processor unit being synchronized to reading by the receiving signal processor unit the availability of the return FIFO channel for emptying and filling the return FIFO channel in the FIFO sequence of the return FIFO channel.

7. A signal processing apparatus according to claim 2, comprising
a further receiver signal processor unit, arranged to read the series of signal data items from the memory,
a further FIFO channel between the source signal processor unit and the further receiver signal processor unit, the source signal processor unit being arranged to successively send the memory address indicators to the further receiver signal processor unit via the further FIFO channel,
a further return FIFO channel coupled between the further receiver signal processor unit and the source signal processor unit, the further receiver signal processor unit being arranged to successively send the memory address indicators back to the source signal processor unit via the further return FIFO channel, when the further receiver signal processor unit has finished reading the corresponding signal data-items, the source signal processor unit receiving the memory address indicators back from the further return FIFO channel, the source signal processor unit reusing a region of the memory for writing a subsequent signal data item when the source signal processor unit has received back the corresponding memory address indicator from both the return FIFO channel and the further return FIFO channel.

8. A signal processing apparatus according to claim 7, wherein operation of the receiver signal processor unit, the receiver signal processor unit and the source signal processor unit are synchronized to one another through the availability of the FIFO channel, the further FIFO channel, the return FIFO channel and the further return FIFO channel for emptying and filling these FIFO channels in their respective FIFO sequences.

9. A signal processing apparatus according to claim 7, comprising a respective counter for each memory address indicator, for counting the number of times the corresponding memory address indicator has been returned after having been sent, the region of memory indicated by each memory address indicator being written into in response to detection that the counter has reached a predetermined value.

10. A method of processing successive signal data items relating to samples along at least one dimension of an at least one dimensional physical signal, the method comprising writing the data items to a memory with a source signal processing unit and reading the data items from memory with a receiver signal processing unit, operation of the source signal unit and the receiver signal processing unit being synchronized by means of a FIFO channel, by successively sending memory address indicators to the receiver signal processor unit via the FIFO channel, each memory address indicator indicating an address of a region in the memory where one of the signal data items has been written, when that one of the signal data items is available for reception, reading and writing of the receiver signal processor unit and the source signal processor unit respectively being synchronized to one another through the availability of the FIFO channel for emptying and filling the FIFO channel in a FIFO sequence.
